(19) United States
(12) Patent Application Publication
(10) Pub. No.: US 2016/0071492 A1
(43) Pub. Date: Mar. 10, 2016

(54) Computer Input Device

(71) Applicant: Peigen Jiang, Sammamish, WA (US)

(72) Inventor: Peigen Jiang, Sammamish, WA (US)

(73) Assignee: Peigen Jiang, Sammamish, WA (US)

(21) Appl. No.: 14/479,305

(22) Filed: Sep. 6, 2014

(51) Int. Cl. G09G 5/18; G06F 3/042; G06F 3/0354; G06F 3/02

(52) U.S. Cl. CPC G09G 5/18; G06F 3/0227; G06F 3/042; G06F 3/03543

(57) ABSTRACT

A computer input method is disclosed which comprises obtaining a time interval elapsed from a time when a key of a keyboard is pressed to a time when the pressed key is released, comparing the time interval with a predetermined time period, and producing a code corresponding to the pressed key in case the time interval is equal to or shorter than the first predetermined time period.

### BACKGROUND

The present invention relates generally to human input devices for computing systems, and, more particularly, to a computer keyboard and mouse combo device.

A most popular way to position a cursor on a computer display is to use a mouse, which functions by detecting two dimensional motions relative to its supporting surface. Physically, a mouse comprises an object held under one of a user's hands, with one or more buttons. Clicking or hovering (stopping movement while the cursor is within the bounds of an area) can select files, programs or actions from a list of names, or (in graphical interfaces) through small images called “icons” and other elements. For example, a text file might be represented by a picture of a paper notebook, and clicking while the cursor hovers over this icon might cause a text editing program to open the file in a window.

When mice have more than one button, software may assign different functions to each button. Often, a primary (leftmost in a right-handed configuration) button on the mouse will select items (primary click), and a secondary (rightmost in a right-handed) button will bring up a menu of alternative actions applicable to that item (secondary click).

A conventional keyboard can detect a pressing of any key thereof, but cannot detect mere touches on the keys. Here, the “touch” refers to a surface of the keyboard being contacted by an object regardless if the key is pressed or not. If the conventional keyboard is a tactile one, the key pressing results from the key being depressed. If the conventional keyboard is a surface one, such as Touch Cover for Microsoft Surface, the key pressing results from a force being applied on the key. As long as the key remains depressed in tactile keyboard or forced upon in surface keyboard, the key is pressed.

While conventional mice can be highly accurate pointing devices for computers, being a separate device the conventional mice have some short-comings, such as every time when a computer user wants to move a cursor, he or she has to move his or her hand away from the keyboard and to the mouse, and move the mouse as a physical object. It is not only less efficient but also may cause injury to the hand over an extended period of time of use.

As such, what is desired is a computer input device, particularly a pointing device that does not rely on moving any additional object other than the user's fingers.

### BRIEF DESCRIPTION OF THE DRAWING

FIG. 1 is a perspective view of a laptop computer with a keyboard.

FIG. 2 illustrates an infrared-light touch sensing system positioned to detect touch on the keyboard surface according to an embodiment of the present invention.

FIG. 3 is a layout diagram of keyboard keys according to the embodiment of the present invention.

FIG. 4 is a block diagram of a computing system with a keyboard-mouse combo device according to the embodiment of present invention.

FIG. 5 is a flow chart diagram illustrating steps of operations of the keyboard-mouse combo device according to an embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein.

### DESCRIPTION

The present invention relates to a computer input device utilizing a touch sensing device and a conventional keyboard to provide cursor input for the computer. A preferred embodiment of the present invention will be described hereinafter with reference to the attached drawings.

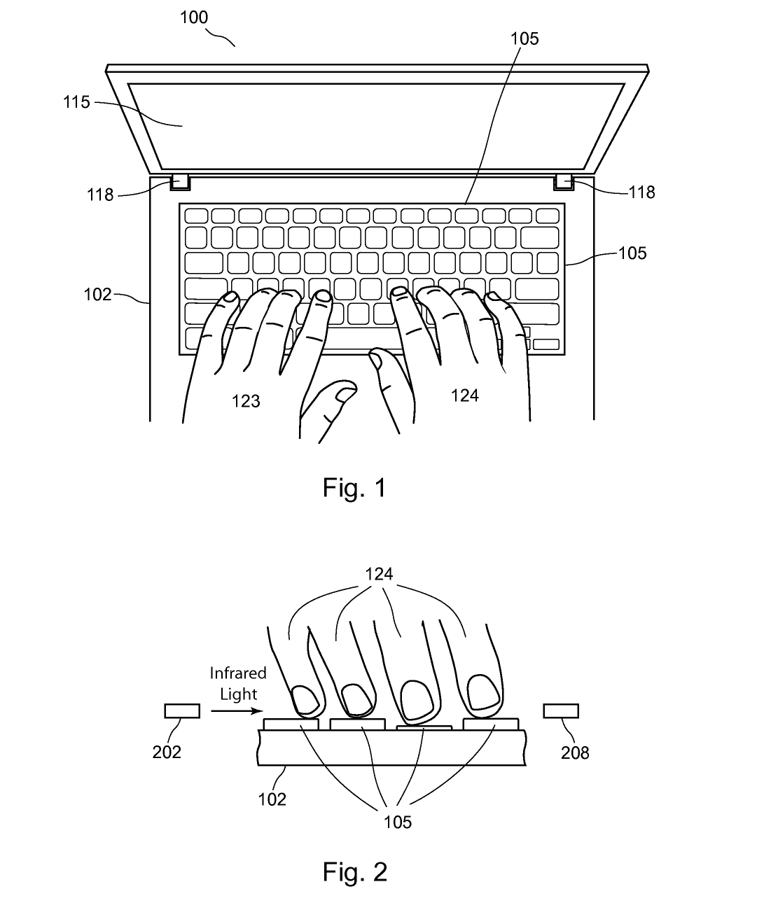

FIG. 1 is a perspective view of a laptop computer 100 with a conventional keyboard 105 for entering text, etc. The laptop computer 100 has a base unit 102 containing the keyboard 105, and a display panel 115 which is hinged to the base unit 102 by hinges 118. A skilled computer user can generally type on the keyboard 105 with both hands 123 and 124.

FIG. 2 illustrates an infrared-light touch sensing system positioned to detect touches on the surface of the keyboard 105 according to an embodiment of the present invention. The infrared-light touch sensing system includes an infrared light emitter 202 and an infrared light receiver 208. The infrared light travels across the surface of the keyboard 105. A finger 124 or any other object touching the surface of the keyboard 105 blocks the infrared light from being received by the infrared light receiver 208. As a result, the touch can be detected.

Referring back to FIG. 1, the infrared light emitter 202 can be positioned along one edge of the keyboard 105 and the infrared light receiver 208 can be positioned along the opposite edge of the keyboard 105. In order to obtain coordinates of a touch, two sets of the infrared light touch sensors will be needed with one set positioned on the horizontal edges and the other on the vertical edges.

Although an infrared-light touch sensing system is described hereinbefore, other touch sensing systems, such as the one using a video camera or ultrasound can also be used.

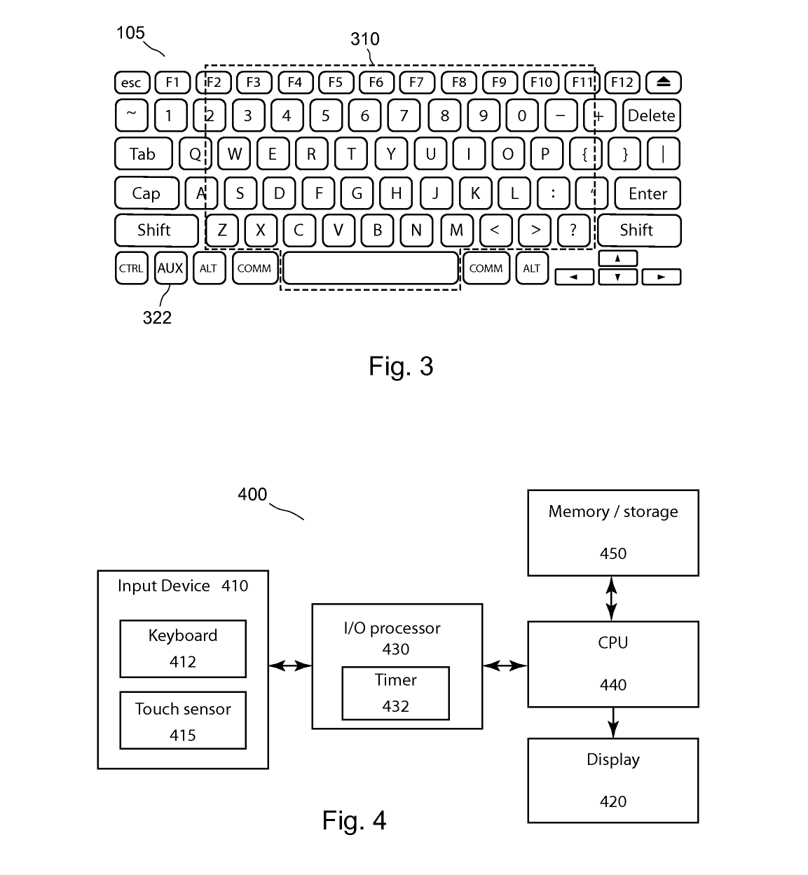

FIG. 3 is a layout diagram of keys of the keyboard 105 according to the embodiment of the present invention. A predetermined touch sensing area 310 is designated by a keyboard-mouse combo (KMC) software for detecting a touch and extracting coordinates of the touch. Only touches within the touch sensing area 310 can be detected as effective touches by the touch sensing system. The predetermined touch sensing area 310 can also be marked out on the surface of the keyboard 105, so that a computer user can clearly identify a boundary of the touching sensing area. The predetermined touch sensing area 310 functions akin to Apple's Magic Trackpad surface area. Apparently, the touch sensing area 310 has to be entirely covered by infrared light. Even though a touch on areas outside of the predetermined touch sensing area 310 can be picked up by the infrared-light sensing system, the KMC software ignores such touch.

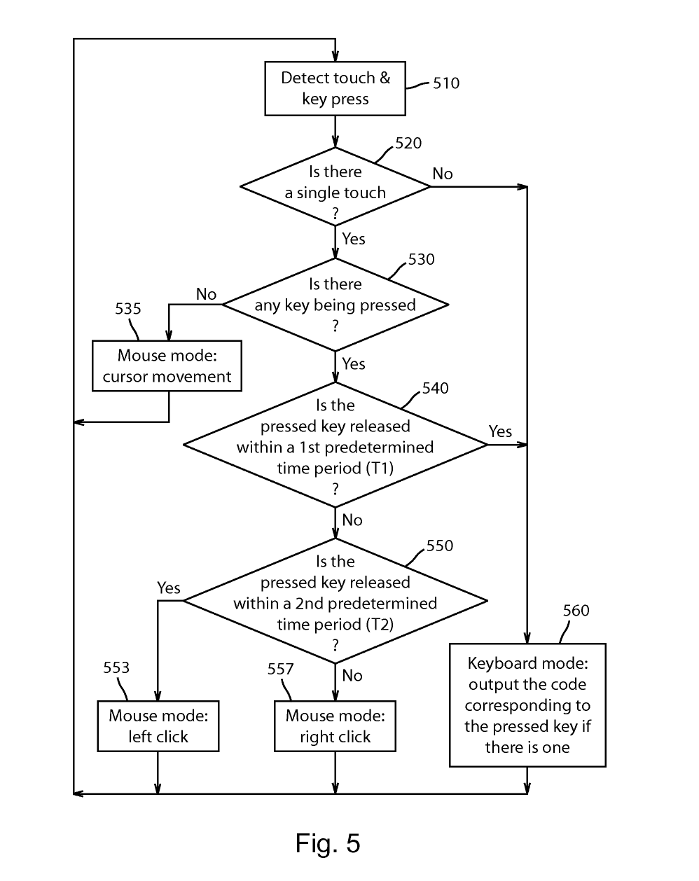

Referring again to FIG. 3, there is a designated key 322 marked as “AUX” which stands for “auxiliary”, outside of the predetermined touch sensing area 310. A main function of the “AUX” key 322 is for switching between a primary click and a secondary click. Operation details of the “AUX” key 322 are depicted in FIG. 5 and associated paragraphs hereinafter. Although only one “AUX” key 322 on the left hand side of the keyboard 105 is illustrated in FIG. 3, a skilled in the art would realize that another “AUX” key can be designated on the right hand side of the keyboard 105 as well.

FIG. 4 is a block diagram of a computing system 400 with a KMC device according to the embodiment of present invention. The computing system 400 includes an input device 410, a display 420, an input/output (I/O) processor 430, a central processing unit (CPU) 440 and a memory and storage unit 450. The input device 410 comprises a conventional keyboard 412 and a touch sensor 415 which overlays the conventional keyboard 410 as described in FIGS. 1-3. The conventional keyboard 412 and the touch sensor 415 form the KMC device. The I/O processor 430 is the hardware that executes the KMC software. The I/O processor 430 also includes a timer 432 for measuring a length of time when a key is pressed.

FIG. 5 is a flow chart diagram illustrating steps of an operation of the KMC device according to an embodiment of the present invention. The keyboard-mouse operation starts with detecting, in step 510, if the touch sensing area 310 is touched and if any key of the keyboard 105 is pressed. The I/O processor 430 distinguishes a single touch from no-touch or multiple touches in step 520. Here the multiple touches refer to a situation when the touch sensing area 310 is simultaneously touched at multiple noncontiguous locations. If there is no single touch, i.e., the touch sensing area 310 is either not touched or simultaneously touched at multiple locations, the keyboard-mouse operation enters into a keyboard mode in step 560, in which when a key is pressed, the I/O processor 430 outputs a code corresponding to the pressed key, and cursor on the display 420 does not move in spite of a touch relocation.

If a single touch is detected in step 520, the keyboard-mouse operation further detects if there is any key being pressed in step 530. In case there is no key being pressed, the keyboard-mouse operation enters into a mouse mode in step 535, in which relocations of the single touch will be interpreted as cursor movement on the display 420. In case a key press is detected in step 530, the keyboard-mouse operation further detects if the pressed key is released within a first predetermined time period (T1) in step 540. In order to execute step 540, the timer 432 is started upon a key is pressed, and stopped when the key is released. Then a time recorded by of the timer 432 is compared with T1. In some embodiments, T1 is set at 300 milliseconds and the value is stored in the I/O processor 430.

In case the pressed key is released within T1 time period in step 540, the keyboard-mouse operation enters into the keyboard mode in step 560 and treats the key press as a keyboard entry. In case the pressed key is released after the T1 time period, the keyboard-mouse operation further detects, in step 550, if the pressed key is released within a second predetermined time period (T2) which is longer than T1. In some embodiments, T2 is set at 2 seconds and the value is stored in the I/O processor 430.

Following step 550, in case the pressed key is released within T2 time period, the keyboard-mouse operation enters into the mouse mode and performs a left click operation in step 553. In case the pressed key is released after the T2 time period, the keyboard-mouse operation enters into the mouse mode and performs a right click operation in step 557.

Referring back to FIG. 5, after every mouse mode or keyboard mode operation (step 535, 553, 557 or 560), the keyboard-mouse operation returns to step 510 and run through the steps depicted in FIG. 5 again. In effect, the touch sensing area 310 keeps detecting touches and the keyboard 105 keeps detecting key presses during an entire time the KMC device is turned on.

Although much of the keyboard-mouse operation steps as described above is executed by the I/O processor 430, in other embodiments, all or some of the same steps may be executed by the CPU 440 instead.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A computer input method comprising:
obtaining a time interval elapsed from a time when a key of a keyboard is pressed to a time when the pressed key is released;
comparing the time interval with a first predetermined time period; and
producing a code corresponding to the pressed key in case the time interval is equal to or shorter than the first predetermined time period.

2. The computer input method of claim 1, wherein the obtaining occurs only when a single touch on a touch sensing area overlaying the keyboard is detected.

3. The computer input method of claim 1 further comprising entering a mouse mode in case the time interval is longer than the first predetermined time period.

4. The computer input method of claim 3 further comprising:
comparing the time interval with a second predetermined time period, the second predetermined time period is longer than the first predetermined time period; and
producing a left click operation in case the time interval is equal to or shorter than the second predetermined time period, and producing a right click operation in case the time interval is longer than the second predetermined time period.

5. The computer input method of claim 1, wherein the keyboard is a tactile keyboard.

6. The computer input method of claim 2, wherein the touch sensing area employs an infrared touch sensor.

7. A computer input method comprising:
obtaining a time interval elapsed from a time when a key of a keyboard is pressed to a time when the pressed key is released when a single touch on a touch sensing area overlaying the keyboard is detected;
comparing the time interval with a first predetermined time period; and
producing a code corresponding to the pressed key in case the time interval is equal to or shorter than the first predetermined time period.

8. The computer input method of claim 7 further comprising entering a mouse mode in case the time interval is longer than the first predetermined time period.

9. The computer input method of claim 8 further comprising:
comparing the time interval with a second predetermined time period, the second predetermined time period is longer than the first predetermined time period; and
producing a left click operation in case the time interval is equal to or shorter than the second predetermined time period, and producing a right click operation in case the time interval is longer than the second predetermined time period.

10. The computer input method of claim 7, wherein the keyboard is a tactile keyboard.

11. The computer input method of claim 7, wherein the touch sensing area employs an infrared touch sensor.
